(19) United States
(12) Patent Application Publication
(10) Pub. No.: US 2024/0056884 A1
(43) Pub. Date: Feb. 15, 2024

(54) TRANSMITTING STATION AND RECEIVING STATION

(71) Applicant: Nippon Telegraph and Telephone Corporation, Tokyo (JP)

(72) Inventors: Yasuhiko INOUE, Musashino-shi, Tokyo (JP); Kengo Nagata, Musashino-shi, Tokyo (JP); Yusuke Asai, Musashino-shi, Tokyo (JP); Yasushi TAKATORI, Musashino-shi, Tokyo (JP); Akira KISHIDA, Musashino-shi, Tokyo (JP)

(21) Appl. No.: 18/269,603

(22) PCT Filed: Dec. 28, 2020
(86) PCT No.: PCT/JP2020/049107

§ 371 Date: Jun. 26, 2023

(51) Int. Cl. H04W 28/04; H04L 1/1607

(52) U.S. Cl. CPC H04W 28/04; H04L 1/1628

(57) ABSTRACT

A transmitting station (TX) of an embodiment includes first and second radio signal processing units (STA1 and STA2) and a link management unit (LM). The first and second radio signal processing units are configured to be able to transmit a radio signal using first and second channels, respectively, and store information indicating a sequence number of data to be transmitted. The link management unit establishes multi-link with the receiving station by using the first radio signal processing unit and the second radio signal processing unit, and manages communication using the multi-link. The link management unit distributes a plurality of data units to the first and second radio signal processing units. The first radio signal processing unit transmits a first data unit group input from the link management unit among the plurality of data units to the receiving station, and stores first information (TBM) indicating the sequence number of the data unit included in the first data unit group.

### TECHNICAL FIELD

An embodiment relates to a transmitting station and a receiving station.

### BACKGROUND ART

A wireless local area network (LAN) is known as an information communication system that wirelessly connects an access point and a wireless terminal apparatus.

### CITATION LIST

### Non Patent Literature

Non Patent Literature 1: IEEE Std 802.11-2016, “9.3.1.8 BlockAckReq frame format” and “9.3.1.9 BlockAck frame format”, 7 Dec. 2016

### SUMMARY OF INVENTION

### Technical Problem

A problem is to improve the efficiency of data communication while using multi-link.

### Means for Solution to Problem

The transmitting station of the embodiment includes a first radio signal processing unit, a second radio signal processing unit, and a link management unit. The first radio signal processing unit is configured to be able to transmit a radio signal using a first channel, and stores information indicating a sequence number of data to be transmitted. The second radio signal processing unit is configured to be able to transmit a radio signal using a second channel different from the first channel, and stores information indicating a sequence number of data to be transmitted. The link management unit establishes multi-link with the receiving station by using the first radio signal processing unit and the second radio signal processing unit, and manages communication using the multi-link. The link management unit distributes a plurality of data units to the first radio signal processing unit and the second radio signal processing unit. The first radio signal processing unit transmits a first data unit group input from the link management unit among the plurality of data units to the receiving station, and stores first information indicating the sequence number of the data unit included in the first data unit group. The second radio signal processing unit transmits a second data unit group input from the link management unit among the plurality of data units to the receiving station, and stores second information indicating the sequence number of the data unit included in the second data unit group.

### Advantageous Effects of Invention

The transmitting station of the embodiment can improve the efficiency of data communication while using multi-link.

### BRIEF DESCRIPTION OF DRAWINGS

FIG. 1 is a conceptual diagram illustrating an example of an overall configuration of an information communication system according to an embodiment.

FIG. 2 is a conceptual diagram illustrating an example of frequency bands used in wireless communication in the information communication system according to the embodiment.

FIG. 3 is a table illustrating an example of a link state of an access point and a wireless terminal apparatus included in the information communication system according to the embodiment.

FIG. 4 is a block diagram illustrating an example of a hardware configuration of the access point included in the information communication system according to the embodiment.

FIG. 5 is a block diagram illustrating an example of a hardware configuration of the wireless terminal apparatus included in the information communication system according to the embodiment.

FIG. 6 is a block diagram illustrating an example of a functional configuration of the access point included in the information communication system according to the embodiment.

FIG. 7 is a block diagram illustrating an example of a functional configuration of the wireless terminal apparatus included in the information communication system according to the embodiment.

FIG. 8 is a block diagram illustrating an example of a functional configuration of a transmitting station in the information communication system according to the embodiment.

FIG. 9 is a block diagram illustrating an example of a functional configuration of a receiving station in the information communication system according to the embodiment.

FIG. 10 is a flowchart illustrating an example of architecture of a MAC layer in the information communication system according to the embodiment.

FIG. 11 is a sequence diagram illustrating an example of a method for transmitting and receiving traffic allocated to one link by the transmitting station and the receiving station in the information communication system according to the embodiment.

FIG. 12 is a conceptual diagram illustrating an example of a format of an A-MPDU used for communication between the transmitting station and the receiving station in the information communication system according to the embodiment.

FIG. 13 is a conceptual diagram illustrating an example of a format of an MPDU used for communication between the transmitting station and the receiving station in the information communication system according to the embodiment.

FIG. 14 is a conceptual diagram illustrating an example of a format of a BlockAck request frame used for communication between the transmitting station and the receiving station in the information communication system according to the embodiment.

FIG. 15 is a conceptual diagram illustrating an example of a format of a BlockAck frame used for communication between the transmitting station and the receiving station in the information communication system according to the embodiment.

FIG. 16 is a flowchart illustrating an example of delivery confirmation processing of the transmitting station in the information communication system according to the embodiment.

FIG. 17 is a conceptual diagram illustrating a specific example of a method for confirming a delivery status by the transmitting station in the information communication system according to the embodiment.

FIG. 18 is a sequence diagram illustrating an example of a method for transmitting and receiving traffic allocated to a plurality of links by the transmitting station and the receiving station in the information communication system according to the embodiment.

### DESCRIPTION OF EMBODIMENTS

Hereinafter, an information communication system 1 according to an embodiment will be described with reference to the drawings. The embodiment illustrates a device and a method for embodying the technical idea of the invention. The drawings are schematic or conceptual. Dimensions, ratios, and the like of each drawing are not necessarily the same as actual ones. The technical idea of the present invention is not specified by the shape, structure, arrangement, and the like of the constituent elements. In the description described below, constituent elements having substantially the same function and configuration are denoted by the same reference numerals. Numbers after the characters constituting the reference numerals are referred to by reference numerals including the same characters, and are used to distinguish between elements having similar configurations. Similarly, each of the numbers and “hyphen+number” after the characters constituting the reference numerals is referred to by reference numerals including the same number, and is used to distinguish between elements having similar configurations. When it is not necessary to distinguish elements indicated by reference numerals containing the same characters or numbers from one another, these elements are referred to by reference numerals containing only characters or numbers.

<1> Configuration

<1-1> Overall Configuration

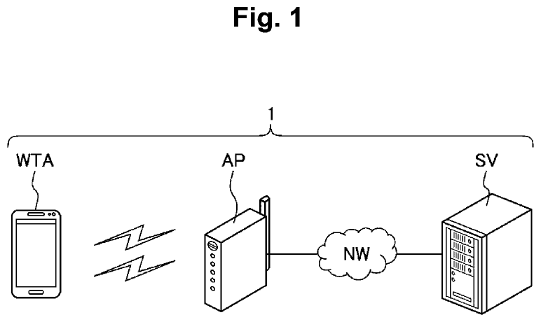

FIG. 1 is a conceptual diagram illustrating an example of an overall configuration of the information communication system 1 according to the embodiment. As illustrated in FIG. 1, the information communication system 1 includes, for example, an access point AP, a wireless terminal apparatus WTA, and a server SV.

The access point AP is a wireless LAN access point or a wireless LAN router, and is configured to be connectable to a network NW. In addition, the access point AP is configured to be wirelessly connectable to one or more wireless terminal apparatuses WTA using one type of band or a plurality of types of bands. Note that the access point AP may be wirelessly connected to a wireless repeater (in other words, wireless range extender, relay station, or repeater), or may be wirelessly connected to both the wireless terminal apparatus WTA and the wireless repeater.

The wireless terminal apparatus WTA is a wireless terminal such as a smartphone or a tablet computer. The wireless terminal apparatus WTA is configured to be wirelessly connectable to the access point AP. Note that the wireless terminal apparatus WTA may be another electronic device such as a desktop computer or a laptop computer. The wireless terminal apparatus WTA may be used as a wireless repeater. In the embodiment, a case where one wireless terminal apparatus WTA is wirelessly connected to the access point AP will be described as an example.

The server SV is a computer configured to be connectable to the network NW, and is configured to be communicable with the access point AP via the network NW. The server SV stores, for example, data of content targeted at the wireless terminal apparatus WTA. The server SV can transmit and receive data to and from the wireless terminal apparatus WTA via the access point AP. Note that communication between the access point AP and the server SV may be wireless or may be a combination of wireless and wired.

The wireless communication between the access point AP and the wireless terminal apparatus WTA conforms to the IEEE 802.11 standard. The IEEE 802.11 standard defines first and second MAC sublayers of an open systems interconnection (OSI) reference model. In the OSI reference model, a communication function is divided into seven layers (the first layer: the physical layer, the second layer: the data link layer, the third layer: the network layer, the fourth layer: the transport layer, the fifth layer: the session layer, the sixth layer: the presentation layer, and the seventh layer: the application layer). The data link layer includes a logical link control (LLC) layer and a media access control (MAC) layer. The LLC layer adds a destination service access point (DSAP) header, a source service access point (SSAP) header, and the like to data input from an upper application to form an LLC packet. The MAC layer adds a MAC header to the LLC packet to form a MAC frame.

In addition, multi-link can be used for wireless connection between the access point AP and the wireless terminal apparatus WTA. The multi-link is a wireless connection capable of transmitting and receiving data using a plurality of links. In a set of the access point AP and the wireless terminal apparatus WTA that are wirelessly connected, one operates as a transmitting station and the other operates as a receiving station. The transmitting station can transmit a radio signal including data input from an upper application by using at least one link constituting the multi-link. The receiving station can receive a radio signal transmitted by the transmitting station, and restore data included in the radio signal by using at least one link constituting the multi-link. In the description described below, a reference sign “TX” is added to the transmitting station, and a reference sign “RX” is added to the receiving station.

(Frequency Band Used by Access Point AP and Wireless Terminal Apparatus WTA)

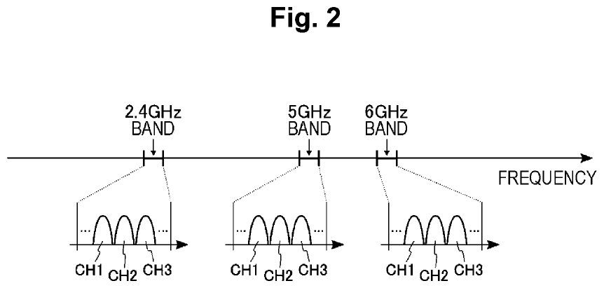

FIG. 2 is a conceptual diagram illustrating an example of frequency bands used in wireless communication in the information communication system 1 according to the embodiment. As illustrated in FIG. 2, in the wireless communication between the access point AP and the wireless terminal apparatus WTA, for example, a 2.4 GHz band, a 5 GHz band, and a 6 GHz band are used. Each frequency band includes a plurality of channels. Specifically, each of the 2.4 GHz band, the 5 GHz band, and the 6 GHz band includes three channels CH1, CH2, and CH3. Note that, for the wireless communication, a frequency band other than the 2.4 GHz band, the 5 GHz band, and the 6 GHz band may be used, and at least one channel CH may be allocated to each frequency band. In the multi-link, two or more channels CH are used. A plurality of channels CH used in the multi-link may be the same frequency band or different frequency bands.

(Example of Link State)

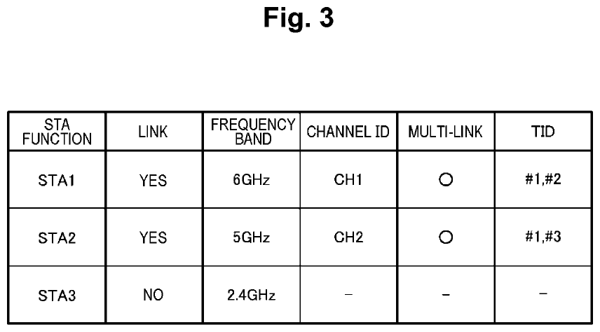

FIG. 3 is a table illustrating an example of a link state of the access point AP and the wireless terminal apparatus WTA included in the information communication system 1 according to the embodiment. The table is included, for example, in a link management unit of the access point AP. The access point AP and the wireless terminal apparatus WTA manage the link state using, for example, the table illustrated in FIG. 3. Hereinafter, the table for managing the multi-link state is referred to as “link management information”. In the embodiment, a case where the multi-link in the state illustrated in FIG. 3 is established will be described as an example. As illustrated in FIG. 3, the link management information includes, for example, information of each of an STA function, a link, a frequency band, a channel ID, a link destination ID, multi-link, and a traffic identifier (TID).

The STA function is a radio signal processing unit included in each of the access point AP and the wireless terminal apparatus WTA. Each of the access point AP and the wireless terminal apparatus WTA can have a plurality of STA functions. One STA function is associated with one link (i.e., channel CH). In the embodiment, each of the access point AP and the wireless terminal apparatus WTA has three STA functions (STA1, STA2, and STA3). STA1, STA2, and STA3 of the access point AP are associated with STA1, STA2, and STA3 of the wireless terminal apparatus WTA, respectively.

In addition, in the embodiment, STA1 of each of the access point AP and the wireless terminal apparatus WTA is associated with the channel CH1 of the 6 GHz band. STA2 of each of the access point AP and the wireless terminal apparatus WTA is associated with the channel CH2 of the 5 GHz band. STA1 and STA2 of each of the access point AP and the wireless terminal apparatus WTA are in a linked state and establish the multi-link. On the other hand, STA3 of each of the access point AP and the wireless terminal apparatus WTA is associated with the 2.4 GHz band and is in a non-linked state.

The TID is an identifier indicating a type of traffic (data). Each of the STA functions transmits and receives the traffic of the TID assigned thereto. Examples of the type of traffic include “, “voice (VO)”, “video (VI)”, “best effort (BE)”, and “background (BK)”. In the multi-link, one STA function may be allocated to one TID, or a plurality of STA functions may be allocated to one TID. In this example, TID #1 is allocated to STA1 and STA2 of each of the access point AP and the wireless terminal apparatus WTA. TID #2 is allocated to STA2 of each of the access point AP and the wireless terminal apparatus WTA. TID #3 is allocated to STA3 of each of the access point AP and the wireless terminal apparatus WTA. Each of TIDs #1 to #3 corresponds to any of VO, VI, BE, and BK.

The traffic and the STA function are associated with each other when the multi-link between the access point AP and the wireless terminal apparatus WTA is established. For example, the association between the traffic and the STA function is set such that the traffic amount (data amount) is equal among a plurality of links constituting the multi-link. It is not limited thereto, and traffic of similar types (priority/non-priority, or the like) may be collected in a specific link constituting the multi-link. A frequency band allocated to transmit and receive traffic is preferably selected according to the type of traffic and the data amount. For example, it is conceivable to associate voice (VO) with a small data amount with a frequency band of 2.4 GHz and associate video (VI) with a large data amount with a frequency band of 5 GHz.

<1-2> Hardware Configuration

Hereinafter, an example of a hardware configuration of each of the access point AP and the wireless terminal apparatus WTA will be described.

<1-2-1> Hardware Configuration of Access Point AP

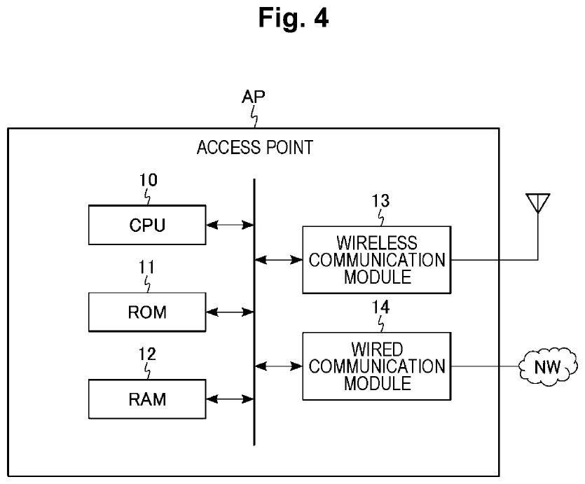

FIG. 4 is a block diagram illustrating an example of a hardware configuration of the access point AP included in the information communication system 1 according to the embodiment. As illustrated in FIG. 4, the access point AP includes a central processing unit (CPU) 10, read only memory (ROM) 11, random access memory (RAM) 12, a wireless communication module 13, and a wired communication module 14.

The CPU 10 is an integrated circuit capable of executing various programs and controls all the operations of the access point AP. The ROM 11 is nonvolatile semiconductor memory and stores a program, control data, and the like for controlling the access point AP. The RAM 12 is, for example, volatile semiconductor memory and is used as a working area of the CPU 10. The wireless communication module 13 is a circuit used to transmit and receive data in accordance with a radio signal and is configured to be connectable to an antenna. In addition, the wireless communication module 13 can include a plurality of communication modules corresponding to a plurality of frequency bands. The wired communication module 14 is a circuit used to transmit and receive data in accordance with a wired signal and is configured to be connectable to the network NW. Note that the access point AP may have another hardware configuration. For example, when the access point AP is wirelessly connected to the network NW, the wired communication module 14 may be omitted from the access point AP.

<1-2-2> Hardware Configuration of Wireless Terminal Apparatus WTA

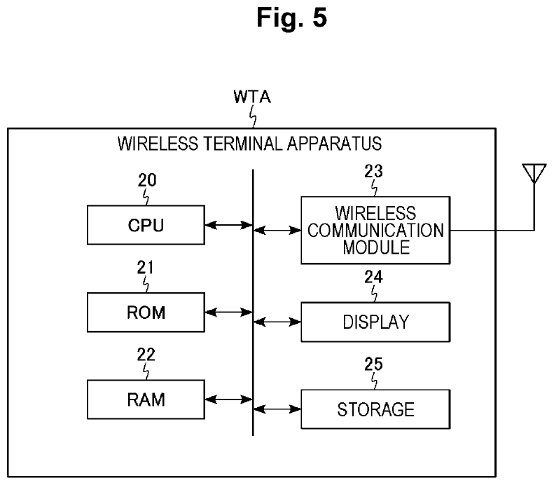

FIG. 5 is a block diagram illustrating an example of a hardware configuration of the wireless terminal apparatus WTA included in the information communication system 1 according to the embodiment. As illustrated in FIG. 5, the wireless terminal apparatus WTA includes, for example, a CPU 20, ROM 21, RAM 22, a wireless communication module 23, a display 24, and a storage 25.

The CPU 20 is an integrated circuit capable of executing various programs and controls all the operations of the wireless terminal apparatus WTA. The ROM 21 is nonvolatile semiconductor memory and stores a program, control data, and the like for controlling the wireless terminal apparatus WTA. The RAM 22 is, for example, volatile semiconductor memory and is used as a working area of the CPU 20. The wireless communication module 23 is a circuit used to transmit and receive data in accordance with a radio signal and is configured to be connectable to an antenna. In addition, the wireless communication module 23 can include, for example, a plurality of communication modules corresponding to a plurality of frequency bands. The display 24 displays, for example, a graphical user interface (GUI) corresponding to application software. The display 24 may have a function as an input interface of the wireless terminal apparatus WTA. The storage 25 is a nonvolatile storage device, and stores, for example, system software or the like of the wireless terminal apparatus WTA. Note that the wireless terminal apparatus WTA may have another hardware configuration. For example, when the wireless terminal apparatus WTA is an Internet of Things (IoT) terminal or the like, the display 24 may be omitted from the wireless terminal apparatus WTA.

<1-3> Functional Configuration

Hereinafter, an example of a functional configuration of the access point AP and an example of a functional configuration of the wireless terminal apparatus WTA will be described. Next, an example of a functional configuration in a case where the access point AP or the wireless terminal apparatus WTA operates as a transmitting station TX and an example of a functional configuration in a case where the access point AP or the wireless terminal apparatus WTA operates as a receiving station RX will be described.

<1-3-1> Functional Configuration of Access Point AP

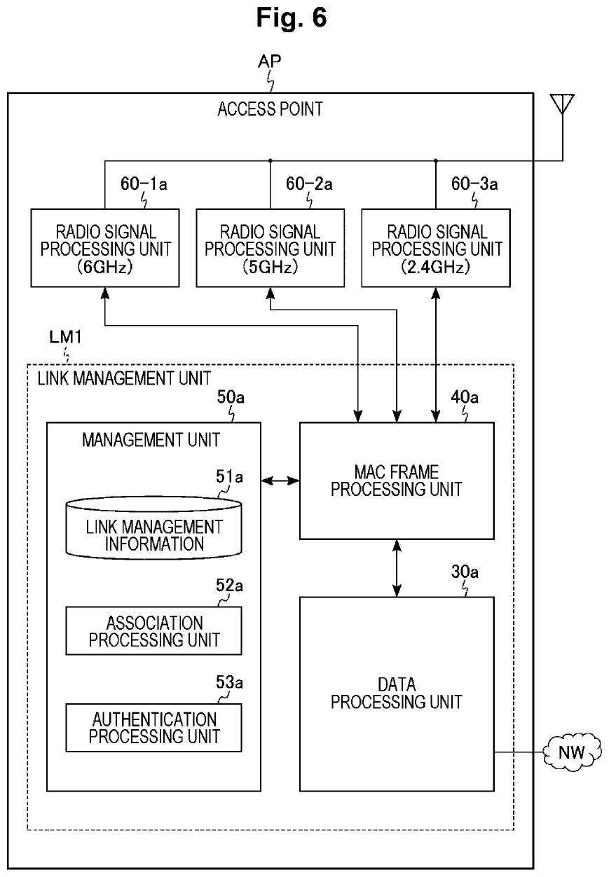

FIG. 6 is a block diagram illustrating an example of a functional configuration of the access point AP included in the information communication system 1 according to the embodiment. As illustrated in FIG. 6, the access point AP includes, for example, a data processing unit 30a, a MAC frame processing unit 40a, a management unit 50a, and radio signal processing units 60-1a, 60-2a, and 60-3a. The processing of the data processing unit 30a, the MAC frame processing unit 40a, the management unit 50a, and the radio signal processing units 60-1a, 60-2a, and 60-3a is realized by, for example, the CPU 10 and the wireless communication module 13.

The data processing unit 30a can execute processing of the LLC layer and an upper layer with respect to input data. When the access point AP is the transmitting station TX, the data processing unit 30a inputs data input from the server SV via the network NW to the MAC frame processing unit 40a. When the access point AP is the receiving station RX, the data processing unit 30a transmits data input from the MAC frame processing unit 40a to the server SV via the network NW.

The MAC frame processing unit 40a executes a part of processing of the MAC layer with respect to the input data. When the access point AP is the transmitting station TX, the MAC frame processing unit 40a generates the MAC frame from the data input from the data processing unit 30a. When the access point AP is the receiving station RX, the MAC frame processing unit 40a restores the data from the MAC frame input from each of the radio signal processing units 60-1a, 60-2a, and 60-3a. In addition, the MAC frame processing unit 40a can also execute processing based on an instruction from the management unit 50a, and exchange information with the management unit 50a.

The management unit 50a manages the link state with the wireless terminal apparatus WTA on the basis of a notification received from the radio signal processing units 60-1a, 60-2a, and 60-3a via the MAC frame processing unit 40a. The management unit 50a includes link management information 51a, an association processing unit 52a, and an authentication processing unit 53a. The link management information 51a is stored, for example, in the RAM 12 and includes information of the wireless terminal apparatus WTA wirelessly connected to the access point AP. The association processing unit 52a executes a protocol related to association when receiving a connection request of the wireless terminal apparatus WTA via any one of the radio signal processing units 60-1a, 60-2a, and 60-3a. The authentication processing unit 53a executes a protocol related to authentication following the connection request.

Each of the radio signal processing units 60-1a, 60-2a, and 60-3a transmits and receives data between the access point AP and the wireless terminal apparatus WTA by wireless communication. Specifically, each of the radio signal processing units 60-1a, 60-2a, and 60-3a can execute a part of the processing of the MAC layer and the processing of the first layer with respect to the input data or the radio signal. When the access point AP is the transmitting station TX, each of the radio signal processing units 60-1a, 60-2a, and 60-3a adds a preamble, a PHY (physical layer) header, or the like to the data input from the MAC frame processing unit 40a to create a radio frame. Then, each of the radio signal processing units 60-1a, 60-2a, and 60-3a converts the radio frame into a radio signal and distributes the converted radio signal via the antenna of the access point AP. When the access point AP is the receiving station RX, each of the radio signal processing units 60-1a, 60-2a, and 60-3a converts the radio signal received via the antenna of the access point AP into a radio frame. Then, each of the radio signal processing units 60-1a, 60-2a, and 60-3a inputs the data included in the radio frame to the MAC frame processing unit 40a. Note that the radio signal processing units 60-1a, 60-2a, and 60-3a may or may not share the antenna of the access point AP. In this example, the radio signal processing units 60-1a, 60-2a, and 60-3a handle radio signals of 6 GHz band, 5 GHz band, and 2.4 GHz band, respectively. That is, the radio signal processing units 60-1a, 60-2b, and 60-3b correspond to STA1, STA2, and STA3 of the access point AP, respectively.

Hereinafter, a set of the data processing unit 30a, the MAC frame processing unit 40a, and the management unit 50a included in the access point AP is referred to as a “link management unit LM1”. The link management unit LM1 can determine the association between the traffic and the STA function when establishing the multi-link between the access point AP and the wireless terminal apparatus WTA.

<1-3-2> Functional Configuration of Wireless Terminal Apparatus WTA

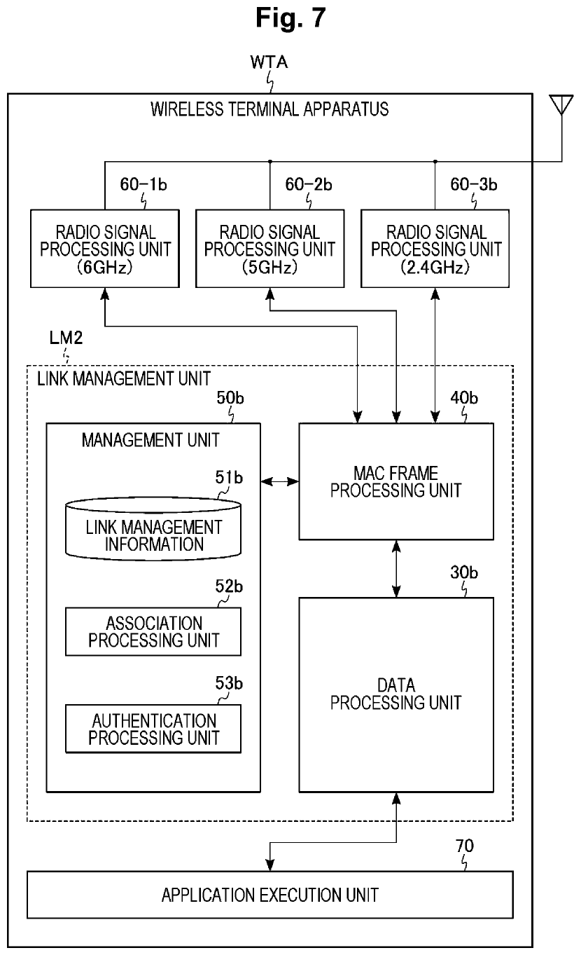

FIG. 7 is a block diagram illustrating an example of a functional configuration of the wireless terminal apparatus WTA included in the information communication system 1 according to the embodiment. As illustrated in FIG. 7, the wireless terminal apparatus WTA includes, for example, a data processing unit 30b, a MAC frame processing unit 40b, a management unit 50b, radio signal processing units 60-1b, 60-2b, and 60-3b, and an application execution unit 70. The processing of the data processing unit 30b, the MAC frame processing unit 40b, the management unit 50b, and the radio signal processing units 60-1b, 60-2b, and 60-3b is realized by, for example, the CPU 20 and the wireless communication module 23. The processing of the application execution unit 70 is realized by, for example, the CPU 20.

The data processing unit 30b can execute processing of the LLC layer and an upper layer with respect to input data. When the wireless terminal apparatus WTA is the transmitting station TX, the data processing unit 30b inputs the data input from the application execution unit 70 to the MAC frame processing unit 40b. When the wireless terminal apparatus WTA is the receiving station RX, the data processing unit 30b inputs the data input from the MAC frame processing unit 40b to the application execution unit 70.

The MAC frame processing unit 40b executes a part of processing of the MAC layer with respect to the input data. When the wireless terminal apparatus WTA is the transmitting station TX, the MAC frame processing unit 40b generates the MAC frame from the data input from the data processing unit 30b. When the wireless terminal apparatus WTA is the receiving station RX, the MAC frame processing unit 40b restores the data from the MAC frame input from each of the radio signal processing units 60-1b, 60-2b, and 60-3b. In addition, the MAC frame processing unit 40b can also execute processing based on an instruction from the management unit 50b, and exchange information with the management unit 50b.

The management unit 50b manages the link state with the access point AP on the basis of a notification received from the radio signal processing units 60-1b, 60-2b, and 60-3b via the MAC frame processing unit 40b. The management unit 50b includes link management information 51b, an association processing unit 52b, and an authentication processing unit 53b. The link management information 51b is stored, for example, in the RAM 22 and includes information of the access point AP wirelessly connected to the wireless terminal apparatus WTA. The association processing unit 52b executes a protocol related to association when receiving a connection request of the wireless terminal apparatus WTA via any one of the radio signal processing units 60-1b, 60-2b, and 60-3b. The authentication processing unit 53b executes a protocol related to authentication following the connection request.

Each of the radio signal processing units 60-1b, 60-2b, and 60-3b transmits and receives data between the access point AP and the wireless terminal apparatus WTA by wireless communication. Specifically, each of the radio signal processing units 60-1b, 60-2b, and 60-3b can execute a part of the processing of the MAC layer and the processing of the first layer with respect to the input data or the radio signal. More specifically, when the wireless terminal apparatus WTA is the transmitting station TX, each of the radio signal processing units 60-1b, 60-2b, and 60-3b adds a preamble, a PHY header, or the like to the data input from the MAC frame processing unit 40b to create a radio frame. Then, each of the radio signal processing units 60-1b, 60-2b, and 60-3b converts the radio frame into a radio signal and distributes the converted radio signal via the antenna of the wireless terminal apparatus WTA. When the wireless terminal apparatus WTA is the receiving station RX, each of the radio signal processing units 60-1b, 60-2b, and 60-3b converts the radio signal received via the antenna of the wireless terminal apparatus WTA into a radio frame. Then, each of the radio signal processing units 60-1b, 60-2b, and 60-3b inputs the data included in the radio frame to the MAC frame processing unit 40b. Note that the radio signal processing units 60-1b, 60-2b, and 60-3b may or may not share the antenna of the wireless terminal apparatus WTA. In this example, the radio signal processing units 60-1b, 60-2b, and 60-3b handle radio signals of 6 GHz band, 5 GHz band, and 2.4 GHz band, respectively. That is, the radio signal processing units 60-1b, 60-2b, and 60-3b correspond to STA1, STA2, and STA3 of the wireless terminal apparatus WTA, respectively.

The application execution unit 70 executes an application that can use the data input from the data processing unit 30b. Then, the application execution unit 70 inputs data to the data processing unit 30b according to the operation of the application, and acquires data from the data processing unit 30b. The application execution unit 70 can cause the display 24 to display information of the application. In addition, the application execution unit 70 can execute processing according to an operation on the input interface.

Hereinafter, a set of the data processing unit 30b, the MAC frame processing unit 40b, and the management unit 50b included in the wireless terminal apparatus WTA is referred to as a “link management unit LM2”. The link management unit LM2 can determine the association between the traffic and the STA function when establishing the multi-link between the access point AP and the wireless terminal apparatus WTA. For example, at the time of multi-link setup, the link management unit LM2 determines association between the traffic and the STA function, and requests the link management unit LM1 of the access point AP to apply the association. Then, when the wireless terminal apparatus WTA receives acknowledgement with respect to the request from the access point AP, the association between the traffic and the STA function is fixed.

<1-3-3> Functional Configuration of Transmitting Station TX

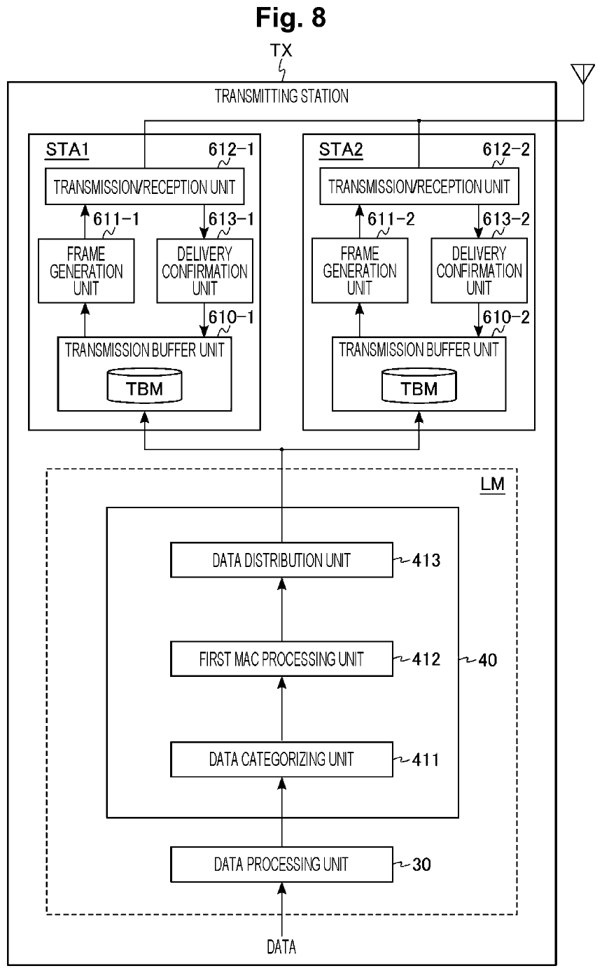

FIG. 8 is a block diagram illustrating an example of a functional configuration of the transmitting station TX in the information communication system 1 according to the embodiment. The transmitting station TX is either the access point AP or the wireless terminal apparatus WTA, and FIG. 8 illustrates a more detailed functional configuration of the access point AP or the wireless terminal apparatus WTA operating as the transmitting station TX. Note that, in FIG. 8, illustration of functional configurations other than the data processing unit 30, the MAC frame processing unit 40, and the two STA functions (STA1 and STA2) is omitted.

As illustrated in FIG. 8, the MAC frame processing unit 40 of the transmitting station TX includes a data categorizing unit 411, a first MAC processing unit 412, and a data distribution unit 413. The STA function of the transmitting station TX includes a transmission buffer unit 610, a frame generation unit 611, a transmission/reception unit 612, and a delivery confirmation unit 613. Specifically, STA1 of the transmitting station TX includes a transmission buffer unit 610-1, a frame generation unit 611-1, a transmission/reception unit 612-1, and a delivery confirmation unit 613-1, and STA2 of the transmitting station TX includes a transmission buffer unit 610-2, a frame generation unit 611-2, a transmission/reception unit 612-2, and a delivery confirmation unit 613-2.

The data categorizing unit 411 classifies the data input from the data processing unit 30 according to the type of traffic. Specifically, the data categorizing unit 411 refers to a TID assigned to the input data and classifies the data into LL data, VO data, VI data, BE data, or BK data. Then, the data categorizing unit 411 inputs the classified data to the first MAC processing unit 412.

The first MAC processing unit 412 executes a part of processing of the MAC layer with respect to the data input from the data categorizing unit 411. Specifically, the first MAC processing unit 412 executes aggregate-MAC service data unit (A-MSDU) aggregation, sequence number allocation, fragmentation, aggregate-MAC protocol data unit (MPDU) encryption, and the like, which will be described below. Then, the first MAC processing unit 412 inputs the data (for example, an encrypted MPDU) on which a part of the processing of the MAC layer has been executed, to the data distribution unit 413. The MPDU corresponds to a unit of data in the MAC layer.

The data distribution unit 413 inputs the data input from the first MAC processing unit 412 to the transmission buffer unit 610 of the STA function associated with the data. Specifically, in the embodiment, the data of TID #1 allocated to STA1 and STA2 is input to either the transmission buffer unit 610-1 of STA1 or the transmission buffer unit 610-2 of STA2. The data of TID #2 allocated to STA1 is input to the transmission buffer unit 610-1 of STA1. The data of TID #3 allocated to STA2 is input to the transmission buffer unit 610-2 of STA2.

The transmission buffer unit 610 of each STA function stores the data input from the data distribution unit 413. The data stored in the transmission buffer unit 610 is managed for each STA function. In addition, the transmission buffer unit 610 of each STA function stores a transmission bitmap TBM. The transmission bitmap TBM includes information regarding the traffic allocated to the STA function. Note that a plurality of functional configurations included in each of the STA functions operate in a similar manner. Therefore, hereinafter, a plurality of functional configurations included in each STA function will be described focusing on one STA function (STA1 of the transmitting station TX).

The frame generation unit 611 executes a part of the processing of the MAC layer on the data stored in the transmission buffer unit 610. Specifically, the frame generation unit 611-1 generates a radio frame by executing addition of a MAC header and an error detection code to be described below, aggregate-MAC protocol data unit (A-MPDU) aggregation, and the like. Then, the frame generation unit 611-1 inputs the generated radio frame (for example, A-MPDU) to the transmission/reception unit 612-1. In addition, after the data stored in the transmission buffer unit 610-1 is wirelessly transmitted, the frame generation unit 611-1 can generate a radio frame including a block acknowledgment (BlockAck) request and input the radio frame to the transmission/reception unit 612-1.

The transmission/reception unit 612-1 executes processing of the physical layer with respect to the radio frame input from the frame generation unit 611-1. The transmission/reception unit 612-1 includes, for example, a transmission queue capable of temporarily storing data for each TID, and has a channel access function capable of executing carrier sense multiple access with collision avoidance (CSMA/CA) or the like. Then, the transmission/reception unit 612-1 transmits the radio signal including the data input from the frame generation unit 611-1 via the antenna. In addition, when receiving the radio signal including BlockAck transmitted by the receiving station RX via the antenna after wirelessly transmitting the data stored in the transmission buffer unit 610-1, the transmission/reception unit 612-1 inputs BlockAck included in the radio signal to the delivery confirmation unit 613-1.

The delivery confirmation unit 613-1 refers to BlockAck information included in BlockAck input from the transmission/reception unit 612-1 and the transmission bitmap TBM and confirms whether or not the data included in the radio frame transmitted by the STA function has been received by the receiving station RX. Then, the delivery confirmation unit 613-1 deletes the data confirmed to having been received by the receiving station RX from the transmission buffer unit 610-1. On the other hand, in a case where there is data confirmed not to be received by the receiving station RX, STA1 executes retransmission processing of the data confirmed not to be received by the receiving station RX. In the embodiment, since the STA function of the transmitting station TX includes the transmission buffer unit 610, data exchange between the STA function and the link management unit LM of the transmitting station TX can be omitted in the retransmission processing.

Note that access parameters in CSMA/CA are allocated such that transmission of a radio signal is prioritized, for example, in the order of VO, VI, BE, and BK. The access parameters include, for example, CWmin, CWmax, AIFS, and TXOPLimit. CWmin and CWmax respectively indicate a minimum value and a maximum value of a contention window which is a transmission standby time for collision avoidance. Arbitration inter frame space (AIFS) indicates a fixed transmission standby time set for each access category for collision avoidance control having a priority control function. TXOPLimit indicates an upper limit value of a transmission opportunity (TXOP) corresponding to the channel occupancy time. For example, the shorter the CWmin and CWmax, the easier the transmission queue can obtain the transmission right. The priority of the transmission queue increases as the AIFS decreases. The amount of data transmitted with one transmission right increases as the value of TXOPLimit increases.

<1-3-4> Functional Configuration of Receiving Station RX

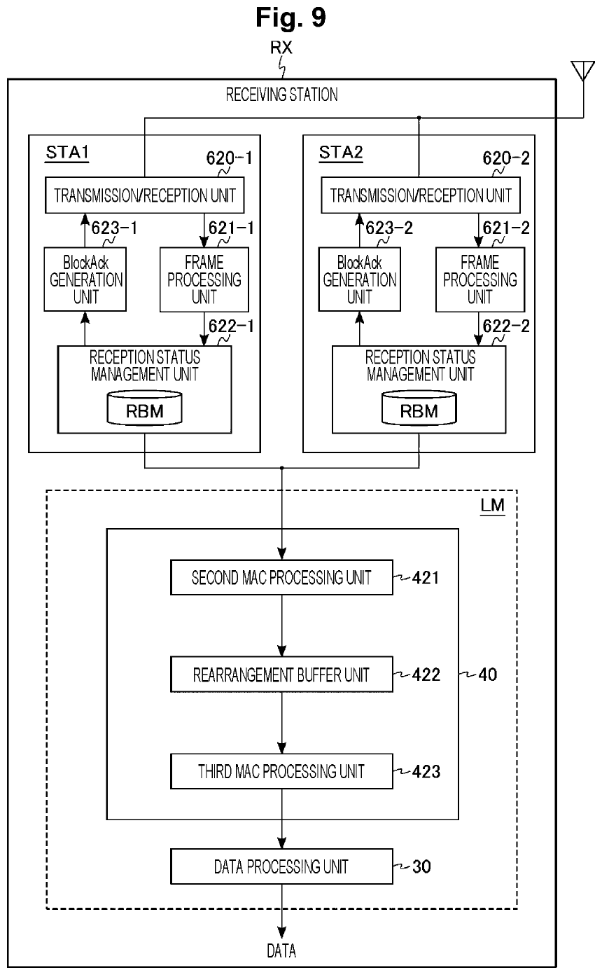

FIG. 9 is a block diagram illustrating an example of a functional configuration of the receiving station RX in the information communication system 1 according to the embodiment. The receiving station RX is either the access point AP or the wireless terminal apparatus WTA, and FIG. 9 illustrates a more detailed functional configuration of the access point AP or the wireless terminal apparatus WTA operating as the receiving station RX. Note that, in FIG. 9, illustration of functional configurations other than the data processing unit 30, the MAC frame processing unit 40, and the two STA functions (STA1 and STA2) is omitted.

As illustrated in FIG. 9, each STA function of the receiving station RX includes a transmission/reception unit 620, a frame processing unit 621, a reception status management unit 622, and a BlockAck generation unit 623. Specifically, STA1 of the receiving station RX includes a transmission/reception unit 620-1, a frame processing unit 621-1, a reception status management unit 622-1, and a BlockAck generation unit 623-1, and STA2 of the receiving station RX includes a transmission/reception unit 620-2, a frame processing unit 621-2, a reception status management unit 622-2, and a BlockAck generation unit 623-2. The MAC frame processing unit 40 of the receiving station RX includes a second MAC processing unit 421, a rearrangement buffer unit 422, and a third MAC processing unit 423. Note that a plurality of functional configurations included in each of the STA functions operate in a similar manner. Therefore, hereinafter, a plurality of functional configurations included in each STA function will be described focusing on one STA function (STA1 of the receiving station RX).

The transmission/reception unit 620-1 executes the processing of the physical layer with respect to the radio signal received via the antenna. When receiving the radio signal including data transmitted by the transmitting station TX via the antenna, the transmission/reception unit 620-1 inputs the data included in the radio signal to the frame processing unit 621-1.

The frame processing unit 621-1 executes a part of processing of the MAC layer with respect to the data input from the transmission/reception unit 620-1. Specifically, the frame processing unit 621-1 executes A-MPDU deaggregation, error detection, and the like described below. Then, the frame processing unit 621-1 inputs the data in which an error is not detected to the reception status management unit 622-1.

The reception status management unit 622-1 inputs data corresponding to the traffic within the data input from the frame processing unit 621-1 to the second MAC processing unit 421. In addition, the reception status management unit 622-1 stores a reception bitmap RBM indicating the data reception status, and updates the reception bitmap RBM on the basis of the data input from the frame processing unit 621-1. Specifically, the reception status management unit 622-1 manages the data reception status corresponding to each sequence number SN with a bit of “0” and “1”. For example, when data is input, the reception status management unit 622-1 updates the corresponding bit in the reception bitmap RBM from “0” to “1”. In addition, when the BlockAck request is included in the data input from the frame processing unit 621-1, the reception status management unit 622-1 instructs the BlockAck generation unit 623-1 to generate and transmit BlockAck, and inputs the reception bitmap RBM to the BlockAck generation unit 623-1.

The BlockAck generation unit 623-1 reads the reception bitmap RBM from the reception status management unit 622-1 on the basis of the instruction of the reception status management unit 622-1, and generates the BlockAck frame including the reception bitmap RBM. Then, the BlockAck generation unit 623-1 inputs the generated BlockAck frame to the transmission/reception unit 620-1. When the BlockAck frame is input, the transmission/reception unit 620-1 transmits a radio signal including the BlockAck frame via the antenna.

The second MAC processing unit 421 executes a part of processing of the MAC layer with respect to the data input from each reception status management unit 622. Specifically, the second MAC processing unit 421 executes MPDU decoding or the like described below. Then, the second MAC processing unit 421 inputs the generated data to the rearrangement buffer unit 422.

The rearrangement buffer unit 422 stores the data (MPDU) input from the second MAC processing unit 421, and rearranges the stored data. The rearrangement of data is executed on the basis of the sequence number SN included in the stored data (MPDU). Then, the rearrangement buffer unit 422 inputs the ordered data to the third MAC processing unit 423.

The third MAC processing unit 423 executes a part of processing of the MAC layer with respect to the data input from the rearrangement buffer unit 422. Specifically, the third MAC processing unit 423 executes defragmentation, A-MSDU deaggregation, or the like, which will be described below. Then, the third MAC processing unit 423 inputs the generated data (MSDU) to the data processing unit 30. Thus, the data included in the radio signal received by the receiving station RX is input to the upper layer.

<2> Operation

Hereinafter, operations of the transmitting station TX and the receiving station RX in the information communication system 1 according to the embodiment will be described. First, an overview of architecture of the MAC layer will be described. Next, an example of a method for transmitting and receiving traffic allocated to one link and an example of a method for transmitting and receiving traffic allocated to a plurality of links while using multi-link will be described.

<2-1> Architecture of MAC Layer

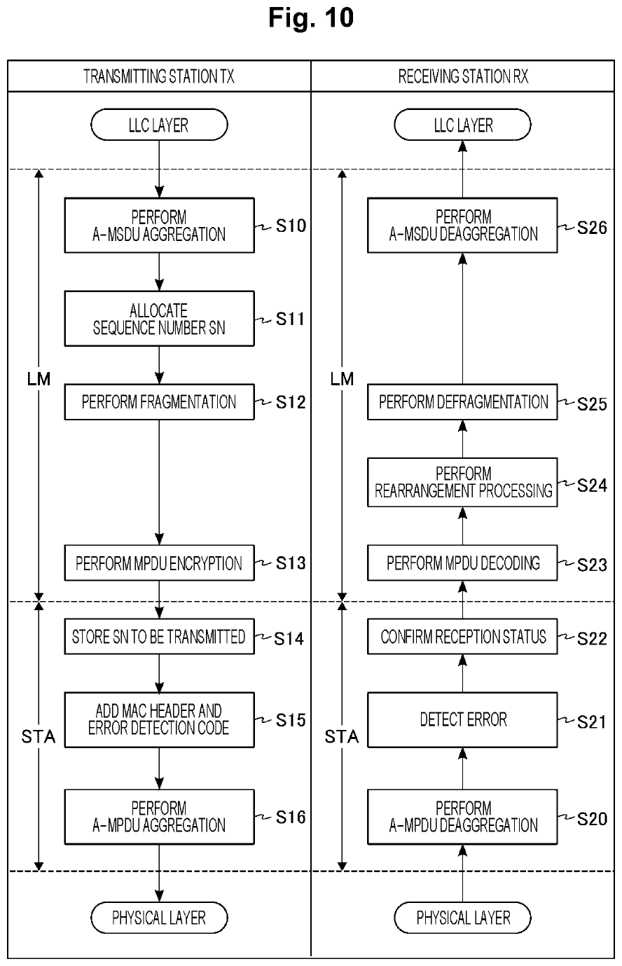

FIG. 10 is a flowchart illustrating an example of architecture of the MAC layer in the information communication system 1 according to the embodiment. The left side of FIG. 10 illustrates an example of architecture of the MAC layer in the transmitting station TX. The right side of FIG. 10 illustrates an example of architecture of the MAC layer in the receiving station RX.

(Processing of Transmitting Station TX)

As illustrated on the left side of FIG. 10, when the processing of the LLC layer with respect to the data to be transmitted is completed, the transmitting station TX sequentially executes the processing of steps S10 to S16 in the MAC layer.

In the processing of step S10, the link management unit LM of the transmitting station TX executes A-MSDU aggregation. A-MSDU aggregation is processing of combining a plurality of MAC service data units (MSDUs) input from the LLC layer to create one A-MSDU. The MSDU is a unit of data handled in the LLC layer. When a plurality of MSDUs has the same receiving station address and the same TID, the link management unit LM of the transmitting station TX can create an A-MSDU using the plurality of MSDUs.

In the processing of step S11, the link management unit LM of the transmitting station TX assigns one sequence number SN to one A-MSDU. The link management unit LM of the transmitting station TX may manage the sequence number SN for each TID or may collectively manage the sequence number SN for a plurality of TIDs. The sequence number SN is used to specify a portion of the data successfully received by the receiving station RX.

In the processing of step S12, the link management unit LM of the transmitting station TX executes fragmentation with respect to one A-MSDU. The fragmentation is processing of fragmenting (dividing) the A-MSDU. Each of the fragmented A-MSDUs corresponds to an MPDU.

In the processing of step S13, the link management unit LM of the transmitting station TX executes MPDU encryption with respect to each of the fragmented A-MPDUs. The MPDU encryption is processing of encrypting the MPDU. The encrypted MPDU is configured to be capable of being decoded between the access point AP and the wireless terminal apparatus WTA whose attribution is established.

In the processing of step S14, the STA function of the transmitting station TX stores the sequence number SN to be transmitted. Specifically, the transmission buffer unit 610 updates the transmission bitmap TBM on the basis of the sequence number SN of the MPDU allocated to the STA function, the sequence number SN being the transmitted sequence number SN of the MPDU.

In the processing of step S15, the STA function of the transmitting station TX executes addition of the MAC header and the error detection code to the encrypted MPDU. The MAC header includes MAC addresses of a destination and a transmission source, EtherType field, and the like. The error detection code is used for error detection of the received data in the receiving station RX. As the error detection code, for example, cyclic redundancy check (CRC) is used.

In the processing of step S16, the STA function of the transmitting station TX executes A-MPDU aggregation. The A-MPDU aggregation is processing of generating one A-MPDU by combining a plurality of MPDUs. The generated A-MPDU is input to the physical layer.

As described above, in the information communication system 1 according to the embodiment, the processing of steps S10 to S13 is executed by the link management unit LM of the transmitting station TX, and the processing of steps S14 to S16 is executed by each STA function of the transmitting station TX. Note that the link management unit LM of the transmitting station TX may constitute the data frame by adding a header including the sequence number SN to the MPDU. That is, the processing of step S15 may be executed by the link management unit LM of the transmitting station TX. In this case, the order of step S14 and step S15 is switched.

(Processing of Receiving Station RX)

As illustrated on the right side of FIG. 10, when the processing of the physical layer with respect to the received radio signal data is completed, the receiving station RX sequentially executes the processing of steps S20 to S26 in the MAC layer.

In the processing of step S20, the STA function of the receiving station RX executes A-MPDU deaggregation. The A-MPDU deaggregation is processing of deaggregating (dividing) the A-MPDU input from the physical layer into units of MPDUs.

In the processing of step S21, the STA function of the receiving station RX executes error detection. The error detection is processing of detecting an error of received data using an error detection code (for example, CRC). The error detection in step S21 is executed for each MPDU.

In the processing of step S22, the STA function of the receiving station RX checks the reception status. Specifically, the STA function of the receiving station RX determines the success or failure of the reception of the data (MPDU) on the basis of the success or failure of the error detection. When no error is detected, that is, when the data is successfully received, the STA function of the receiving station RX executes next processing using the data. On the other hand, when an error is detected, the STA function of the receiving station RX discards the data in which the error has been detected. In addition, the STA function of the receiving station RX generates the reception bitmap RBM based on the reception status, and transmits the BlockAck including the reception bitmap RBM to the transmitting station TX.

In the processing of step S23, the link management unit LM of the receiving station RX executes MPDU decoding. The MPDU decoding is processing of decoding the encrypted MPDU. The decoding of the MPDU is successful in the case of data communicated between the access point AP and the wireless terminal apparatus WTA whose attribution is established.

In the processing of step S24, the link management unit LM of the receiving station RX executes processing of rearranging the decoded MPDUs. The rearrangement processing is processing of rearranging the MPDUs which have been successfully received in order of the sequence number SN.

In the processing of step S25, the link management unit LM of the receiving station RX executes defragmentation of the rearranged MPDUs. The defragmentation is processing of restoring the A-MSDU by combining a plurality of MPDUs.

In the processing of step S26, the link management unit LM of the receiving station RX executes A-MSDU deaggregation. The A-MSDU deaggregation is processing of dividing the restored A-MSDU into units of MSDUs. The divided A-MSDUs are input to the LLC layer.

As described above, in the information communication system 1 according to the embodiment, the processing of steps S20 to S22 is executed by each STA function of the receiving station RX, and the processing of steps S23 to S26 is executed by the link management unit LM of the receiving station RX.

<2-2> Method for Transmitting and Receiving Traffic Allocated to One Link

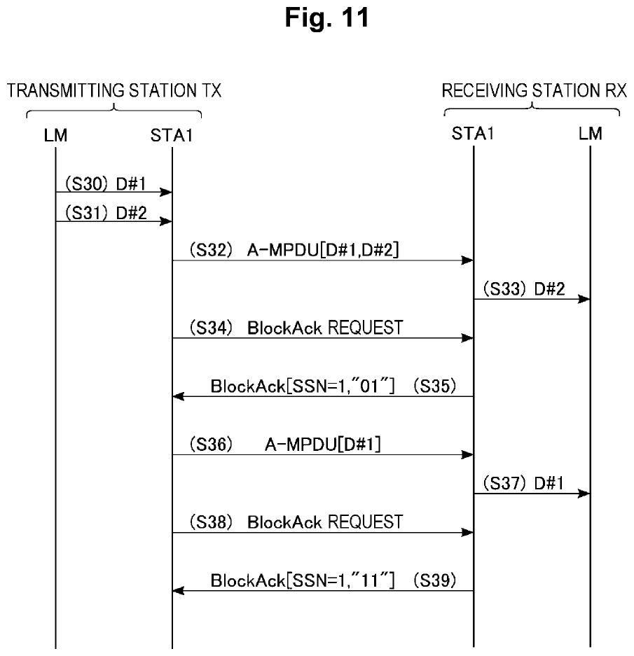

FIG. 11 is a sequence diagram illustrating an example of a method for transmitting and receiving traffic allocated to one link by the transmitting station TX and the receiving station RX in the information communication system 1 according to the embodiment. An overview of an operation in which data D #1 and D #2 having the same TID are transmitted from the transmitting station TX to the receiving station RX using one link (STA1) will be described below with reference to FIG. 11.

When the data D #1 and D #2 are input from the upper layer, the link management unit LM of the transmitting station TX starts processing of transmitting the data D #1 and D #2.

First, the link management unit LM of the transmitting station TX inputs the data D #1 to which SN=1 is allocated to STA1 of the transmitting station TX (step S30). The data D #1 is stored in the transmission buffer unit 610-1 of STA1 of the transmitting station TX.

Next, the link management unit LM of the transmitting station TX inputs the data D #2 to which SN=2 is allocated to STA1 of the transmitting station TX (step S31). The data D #2 is stored in the transmission buffer unit 610-1 of STA1 of the transmitting station TX.

Subsequently, STA1 of the transmitting station TX transmits an A-MPDU [D #1, D #2] including an MPDU including the data D #1 and an MPDU including the data D #2 to STA1 of the receiving station RX (step S32).

In this example, STA1 of the receiving station RX that has received the A-MPDU [D #1, D #2] detects an error in the MPDU including the data D #1 and does not detect an error in the MPDU including the data D #2. In this case, STA1 of the receiving station RX inputs the data D #2 received from the transmitting station TX to the link management unit LM of the receiving station RX (step S33). In addition, STA1 of the receiving station RX updates the reception bitmap RBM of STA1 of the receiving station RX on the basis of the result of receiving the A-MPDU [D #1, D #2].

When the transmission of the A-MPDU [D #1, D #2] is completed, STA1 of the transmitting station TX transmits a BlockAck request to STA1 of the receiving station RX (step S34).

Upon receiving the BlockAck request, STA1 of the receiving station RX transmits BlockAck [SSN=1, “01”] corresponding to the result of receiving the A-MPDU [D #1, D #2] to STA1 of the transmitting station TX (step S35). [SSN=1, “01”] indicates the content of the reception bitmap RBM. SSN=1 indicates that a start sequence number SSN indicated by the BlockAck request is “1”. “01” corresponds to the bitmap information included in the reception bitmap RBM. The first number in “01” indicates a reception result of the MPDU corresponding to the start sequence number SSN. The second number in “01” indicates a reception result of the MPDU corresponding to the sequence number SN subsequent to the start sequence number SSN. “0” of the bitmap information included in the reception bitmap RBM indicates that the reception of the MPDU having the associated sequence number SN has failed. “1” of the bitmap information included in the reception bitmap RBM indicates that the reception of the MPDU having the associated sequence number SN has succeeded.

Upon receiving BlockAck [SSN=1, “01”], STA1 of the transmitting station TX refers to the start sequence number SSN and the bitmap information included in BlockAck. In the present example, on the basis of the fact that the numerical value associated with SN=2 in the reception bitmap RBM is “1”, STA1 of the transmitting station TX deletes the data D #2 of SN=2 from the transmission buffer unit 610-1. On the other hand, STA1 of the transmitting station TX executes the retransmission processing of the data D #1 of SN=1 on the basis of the fact that the numerical value associated with SN=1 in the reception bitmap RBM is “0”. Specifically, STA1 of the transmitting station TX transmits an A-MPDU [D #1] including an MPDU including the data D #1 to STA1 of the receiving station RX (step S36).

In this example, STA1 of the receiving station RX that has received the A-MPDU [D #1] does not detect an error in the MPDU including the data D #1. In this case, STA1 of the receiving station RX inputs the data D #1 received from the transmitting station TX to the link management unit LM of the receiving station RX (step S37). In addition, STA1 of the receiving station RX updates the reception bitmap RBM of STA1 of the receiving station RX on the basis of the result of receiving the A-MPDU [D #1].

When the transmission of the A-MPDU [D #1] is completed, STA1 of the transmitting station TX transmits a BlockAck request to STA1 of the receiving station RX (step S38).

Upon receiving the BlockAck request, STA1 of the receiving station RX transmits BlockAck [SSN=1, “11”] corresponding to the result of receiving the A-MPDU [D #1] to STA1 of the transmitting station TX (step S39).

Upon receiving BlockAck [SSN=1, “11”], on the basis of the fact that the numerical value associated with SN=1 in the reception bitmap RBM is “1”, STA1 of the transmitting station TX deletes the data of SN=1 from the transmission buffer unit 610. Then, the transmitting station TX completes the transmission processing of the data D #1 and D #2 to the receiving station RX in response to the deletion of the data D #1 and D #2 stored in the transmission buffer unit 610-1.

(Format of A-MPDU)

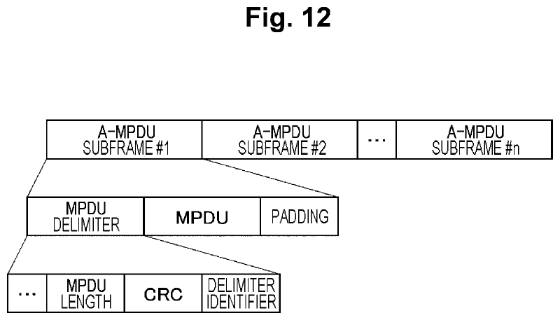

FIG. 12 is a conceptual diagram illustrating an example of a format of an A-MPDU used for communication between the transmitting station TX and the receiving station RX in the information communication system 1 according to the embodiment. As illustrated in FIG. 12, fields included in the A-MPDU include, for example, an A-MPDU subframe #1, an A-MPDU subframe #2, . . . , and an A-MPDU subframe #n (n is an integer of three or more). The A-MPDU subframe includes a plurality of fields each of which is capable of performing error detection. Specifically, the A-MPDU subframe includes an MPDU delimiter, an MPDU, and padding. The MPDU delimiter includes an MPDU length, CRC, and a delimiter identifier. The MPDU length indicates the length of the MPDU included in the A-MPDU subframe. The CRC in the MPDU is used for error detection of the MPDU delimiter. The delimiter identifier is used to detect the MPDU delimiter. The MPDU includes, for example, a data frame. Note that the format of the A-MPDU may be another format.

(Format of MPDU)

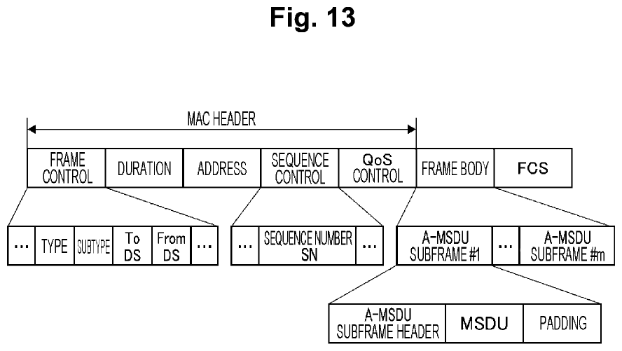

FIG. 13 is a conceptual diagram illustrating an example of a format of an MPDU used for communication between the transmitting station TX and the receiving station RX in the information communication system 1 according to the embodiment. As illustrated in FIG. 13, the fields included in the MPDU include, for example, a frame control field, a duration field, an address field, a sequence control field, a quality of service (QoS) control field, a frame body field, and a frame check sequence (FCS) field. These fields may or may not be included depending on the type of radio frame.

The frame control field, the duration field, the address field, the sequence control field, and the QoS control field correspond to a header (MAC header) of the MPDU. The frame body field is, for example, a field in which data is stored. The FCS field stores an error detection code of a set of the MAC header and the frame body field, and is used to determine the presence or absence of an error in the data frame.

The frame control field stores various control information. For example, the frame control field includes a type value, a subtype value, a to distribution system (To DS) value, and a from distribution system (From DS) value. The type value indicates the frame type of the radio frame. For example, Type value “00” indicates that the radio frame is a management frame. Type value “01” indicates that the radio frame is a control frame. Type value “10” indicates that the radio frame is a data frame. The content of the radio frame varies depending on a combination of the type value and the subtype value. For example, “00/1000 (Type value/Subtype value)” indicates that the radio frame is a beacon signal. The meanings of the To DS value and the From DS value vary depending on the combination of them. For example, “00(To DS/From DS)” indicates data between terminals in the same independent basic service set (IBSS). “10(To DS/From DS)” indicates that the data frame is externally directed to the distribution system (DS). “01(To DS/From DS)”” indicates that the data frame is directed to the outside of the DS. “11(To DS/From DS)” is used when a mesh network is configured.

The duration field indicates a scheduled period of use of a wireless line. The address field indicates a BSSID, a transmission source address, a destination address, an address of a transmitter terminal, an address of a receiver terminal, and the like. The sequence control field can include a sequence number SN of data frame, a fragment number for fragmentation, and the like. The QoS control field includes, for example, TID information. The TID information may be inserted at another position in the radio frame. The frame body field includes information corresponding to the type of the frame. For example, when the radio frame is a data frame, the frame body field stores a plurality of A-MSDU subframes #1 to #m (m is an integer of two or more). Each of the A-MSDU subframes stores an A-MSDU subframe header, an MSDU, and padding. The MSDU stores data to be communicated between the wireless terminal apparatus WTA and the access point AP.

(Format of BlockAck Request)

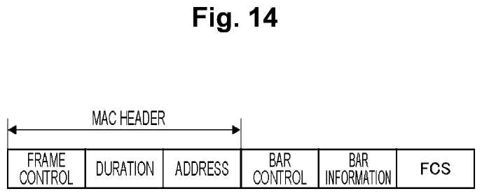

FIG. 14 is a conceptual diagram illustrating an example of a format of a BlockAck request frame used for communication between the transmitting station TX and the receiving station RX in the information communication system 1 according to the embodiment. As illustrated in FIG. 14, the fields included in the BlockAck request frame include a frame control field, a duration field, an address field, a BlockAck request (BAR) control field, a BAR information field, and an FCS field. The configuration of each of the frame control field, the duration field, the address field, and the FCS field is similar to that of the data frame. The BAR control field indicates information regarding control of the BlockAck request. The BAR information field indicates, for example, the smallest number among the sequence numbers SN of the MAC frame for which BlockAck is to be requested. Note that the format of the BlockAck request frame may be another format.

(Format of BlockAck)

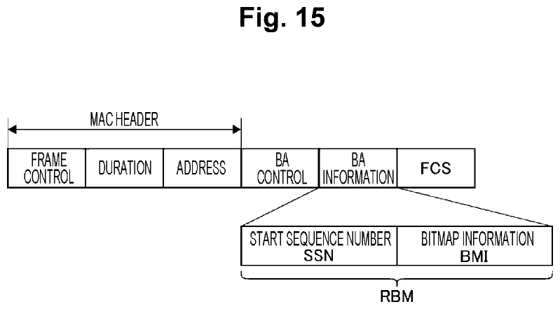

FIG. 15 is a conceptual diagram illustrating an example of a format of a BlockAck frame used for communication between the transmitting station TX and the receiving station RX in the information communication system 1 according to the embodiment. As illustrated in FIG. 15, the fields included in the BlockAck frame include a frame control field, a duration field, an address field, a BlockAck (BA) control field, a BA information field, and an FCS field. The configuration of each of the frame control field, the duration field, the address field, and the FCS field is similar to that of the data frame. The BA control field indicates information indicating the type of BlockAck. The BA information field includes a reception bitmap RBM. The reception bitmap RBM includes a start sequence number SSN and bitmap information BMI. Note that the format of the BlockAck frame may be another format.

<2-3> Method for Transmitting and Receiving Traffic Allocated to a Plurality of Links

In the information communication system 1 according to the embodiment, when the transmitting station TX for which the multi-link is established transmits the traffic allocated to a plurality of links to the receiving station RX, the transmission bitmap TBM including the sequence number SN of the data to be transmitted is stored for each STA function. Then, the STA function of the transmitting station TX confirms whether or not the data delivery is successful on the basis of the transmission bitmap TBM and the reception bitmap RBM in BlockAck. Hereinafter, a method for transmitting and receiving traffic allocated to a plurality of links will be described mainly with respect to differences from the method for transmitting and receiving traffic allocated to one link.

(Processing of Transmitting Station TX)

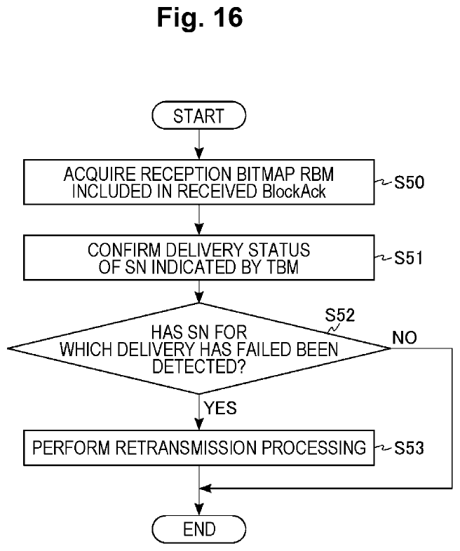

FIG. 16 is a flowchart illustrating an example of delivery confirmation processing of the transmitting station TX in the information communication system 1 according to the embodiment. The delivery confirmation processing illustrated in FIG. 16 is started when the transmitting station TX receives BlockAck from the receiving station RX.

First, the delivery confirmation unit 613 of the transmitting station TX confirms the reception bitmap RBM included in the received BlockAck (step S50). Specifically, the delivery confirmation unit 613 confirms the allocation of the sequence number SN in the bitmap information BMI included in the reception bitmap RBM on the basis of the start sequence number SSN in the reception bitmap RBM.

Subsequently, the delivery confirmation unit 613 confirms the delivery status of the sequence number SN indicated by the transmission bitmap TBM in the transmission buffer unit 610 (step S51). Specifically, the delivery confirmation unit 613 sets the sequence number SN allocated to the bit of “1” in the transmission bitmap TBM as a target to be confirmed as to the delivery status. Then, the delivery confirmation unit 613 refers to the bit corresponding to the target sequence number SN in the reception bitmap RBM and confirms whether the data corresponding to the bit can be received.

Then, the delivery confirmation unit 613 of the transmitting station TX confirms whether or not the sequence number SN for which delivery has failed has been detected (step S52).

In a case where the sequence number SN for which delivery has failed is detected (step S52, YES), the delivery confirmation unit 613 causes the STA function to execute retransmission processing of the MPDU corresponding to the sequence number SN for which delivery has failed (step S53). In the retransmission processing, the transmitting station TX notifies the receiving station RX of the smallest sequence number SN among the sequence numbers SN for which delivery has failed. Then, the transmitting station TX updates the start sequence number SSN of the transmission bitmap TBM with the smallest sequence number SN in the data to be retransmitted. Upon receiving the notification from the transmitting station TX, the receiving station RX updates the start sequence number SSN of the reception bitmap RBM. Thus, data reception statuses can be synchronized between the transmitting station TX and the receiving station RX. Note that, in the retransmission processing, the transmitting station TX may notify the receiving station RX of the last sequence number SN among the sequence numbers SN for which delivery has succeeded. Even in such a case, data reception statuses can be synchronized between the transmitting station TX and the receiving station RX.

In a case where the sequence number SN for which delivery has failed is not detected (step S52, NO), the delivery confirmation unit 613 deletes the MPDU corresponding to the sequence number SN for which delivery has succeeded from the transmission buffer unit 610 and ends the delivery confirmation processing. At this time, the transmitting station TX notifies the receiving station RX of the last sequence number SN among the sequence numbers SN for which delivery has succeeded. Upon receiving the notification from the transmitting station TX, the receiving station RX updates the start sequence number SSN in the reception bitmap RBN.

In the information communication system 1 according to the embodiment, the delivery confirmation operation of the transmitting station TX may be executed not only in the case of transmitting the traffic allocated to a plurality of links but also in the case of transmitting the traffic allocated to one link.

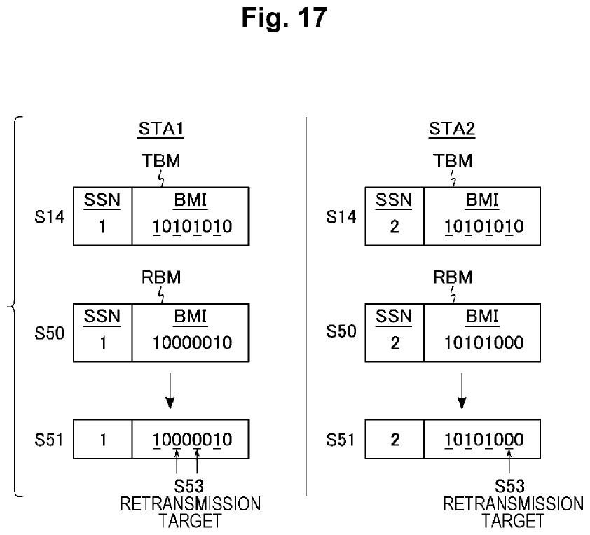

FIG. 17 is a conceptual diagram illustrating a specific example of a method for confirming a delivery status by the transmitting station TX in the information communication system 1 according to the embodiment. Hereinafter, a specific example of a method for confirming the delivery status by the STA function of the transmitting station TX will be described with reference to FIGS. 10 and 17 as appropriate.

In this example, STA1 of the transmitting station TX stores a transmission bitmap TBM [SSN=1, BMI=“10101010”] (step S14). Then, after transmitting the A-MPDU associated with the transmission bitmap TBM to the receiving station RX, STA1 of the transmitting station TX receives BlockAck including the reception bitmap RBM [SSN=1, BMI=“10000010”] (step S50). Then, on the basis of the transmission bitmap TBM [SSN=1, BMI=“10101010”], STA1 of the transmitting station TX confirms the respective delivery statuses of the data associated with SN=1, SN=3, SN=5, and SN=7 in the reception bitmap [SSN=1, BMI=“10000010”] (step S51). In this example, in the reception bitmap RBM, since the bit associated with SN=1 and the bit associated with SN=7 are each “1”, STA1 of the transmitting station TX senses that the data of SN=1 and the data of SN=7 are successfully delivered. On the other hand, in the reception bitmap RBM, since the bit associated with SN=3 and the bit associated with SN=5 are each “0”, STA1 of the transmitting station TX senses that the data of SN=3 and the data of SN=5 have failed to be delivered, i.e., are to be retransmitted.

The processing in STA2 of the transmitting station TX is similar to the processing in STA of the transmitting station TX. In this example, STA2 of the transmitting station TX stores a transmission bitmap TBM [SSN=2, BMI=“10101010”] (step S14). Then, after transmitting the A-MPDU associated with the transmission bitmap TBM to the receiving station RX, STA2 of the transmitting station TX receives BlockAck including the reception bitmap RBM [SSN=2, BMI=“10101000”] (step S50). Then, on the basis of the transmission bitmap TBM [SSN=2, BMI=“10101010”], STA2 of the transmitting station TX confirms the respective delivery statuses of the data associated with SN=2, SN=4, SN=6, and SN=8 in the reception bitmap [SSN=2, BMI=“10101000”] (step S51). In this example, in the reception bitmap RBM, since the bit associated with SN=2, the bit associated with SN=4, and the bit associated with SN=6 are each “1”, STA2 of the transmitting station TX senses that the data of SN=2, the data of SN=4, and the data of SN=6 are each successfully delivered. On the other hand, in the reception bitmap RBM, since the bit associated with SN=8 is “0”, STA2 of the transmitting station TX senses that the data of SN=8 has failed to be delivered, i.e., is to be retransmitted.

As described above, each STA function of the transmitting station TX confirms the missing number of the sequence number SN by the transmission bitmap TBM, and confirms the delivery status of only the sequence number SN excluding the missing number in the reception bitmap RBM included in the received BlockAck. Note that each STA function of the transmitting station TX may update the transmission bitmap TBM after confirming the delivery status, or may update the transmission bitmap TBM at the time of data retransmission processing. The number of each bit in the transmission bitmap TBM may be another number as long as it is possible to distinguish whether it is a transmission target.

(Specific Example of Transmission and Reception of Traffic Allocated to a Plurality of Links)

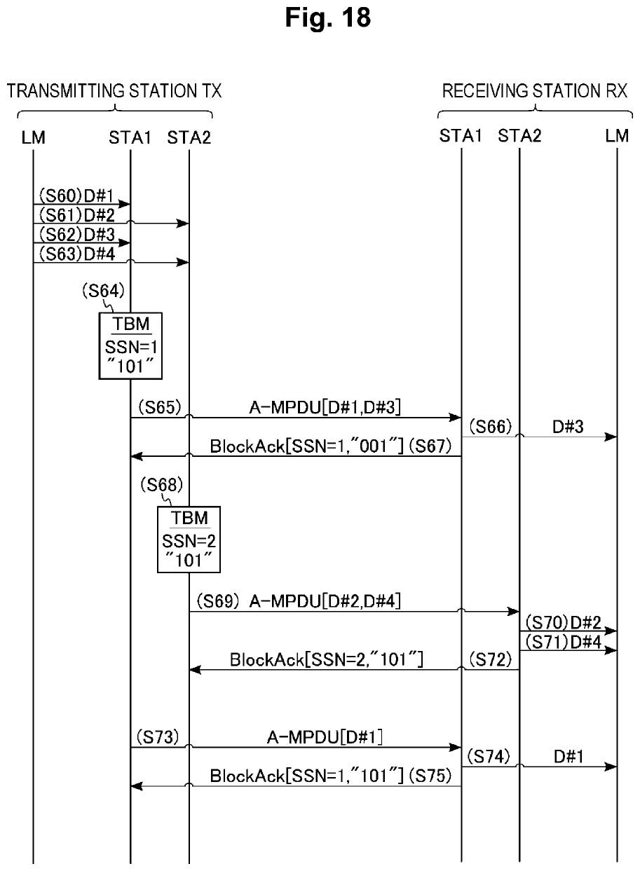

FIG. 18 is a sequence diagram illustrating an example of a communication method using a plurality of links by the transmitting station TX and the receiving station RX in the information communication system 1 according to the embodiment. An overview of an operation in which data D #1, D #2, D #3, and D #4 having the same TID are transmitted from the transmitting station TX to the receiving station RX using a plurality of links (STA1 and STA2) will be described below with reference to FIG. 18.

When the data D #1, D #2, D #3, and D #4 are input from the upper layer, the link management unit LM of the transmitting station TX starts processing of transmitting the data D #1, D #2, D #3, and D #4.

First, the link management unit LM of the transmitting station TX inputs the data D #1 to which SN=1 is allocated, to STA1 of the transmitting station TX (step S60). The data D #1 is stored in the transmission buffer unit 610-1 of STA1 of the transmitting station TX.

Next, the link management unit LM of the transmitting station TX inputs the data D #2 to which SN=2 is allocated, to STA2 of the transmitting station TX (step S61). The data D #2 is stored in the transmission buffer unit 610-2 of STA2 of the transmitting station TX.

Next, the link management unit LM of the transmitting station TX inputs the data D #3 to which SN=3 is allocated, to STA1 of the transmitting station TX (step S62). The data D #3 is stored in the transmission buffer unit 610-1 of STA1 of the transmitting station TX.

Next, the link management unit LM of the transmitting station TX inputs the data D #4 to which SN=4 is allocated, to STA2 of the transmitting station TX (step S63). The data D #4 is stored in the transmission buffer unit 610-2 of STA2 of the transmitting station TX.

As described above, in the present example, data is input to each of STA1 and STA2 of the transmitting station TX. A transmission sequence of data by STA1 of each of the transmitting station TX and the receiving station RX and a transmission sequence of data by STA2 of each of the transmitting station TX and the receiving station RX can be executed in parallel. For brevity of description, first, the transmission of the A-MPDU by STA1 of the transmitting station TX will be described.

STA1 of the transmitting station TX updates the transmission bitmap TBM in the transmission buffer unit 610-1 (step S64). In this example, [SSN=1, “101”] is stored in the transmission buffer unit 610-1. [SSN=1, “101”] indicates that the data D #1 of SN=1 and the data D #3 of SN=3 are included in the A-MPDU to be subsequently transmitted by the STA of the transmitting station TX.

Then, STA1 of the transmitting station TX transmits an A-MPDU [D #1, D #3] including an MPDU including the data D #1 and an MPDU including the data D #3 to STA1 of the receiving station RX (step S65). In this example, STA1 of the receiving station RX that has received the A-MPDU [D #1, D #3] detects an error in the MPDU including the data D #1 and does not detect an error in the MPDU including the data D #3.

In this case, STA1 of the receiving station RX inputs the data D #3 received from the transmitting station TX to the link management unit LM of the receiving station RX (step S66).

In addition, STA1 of the receiving station RX updates the reception bitmap RBM of STA1 of the receiving station RX on the basis of the result of receiving the A-MPDU [D #1, D #3]. Then, in response to the BlockAck request, which is not illustrated, STA1 of the receiving station RX transmits BlockAck [SSN=1, “001”] corresponding to the result of receiving the A-MPDU [D #1, D #3] to STA1 of the transmitting station TX (step S66). [SSN=1, “001”] indicates that the data D #3 of SN=3 has been successfully received.

Next, the transmission sequence of the A-MPDU by STA2 of the transmitting station TX will be described.

STA2 of the transmitting station TX updates the transmission bitmap TBM in the transmission buffer unit 610-2 (step S68). In this example, [SSN=2, “101”] is stored in the transmission buffer unit 610-2. [SSN=2, “101”] indicates that the data D #2 of SN=2 and the data D #4 of SN=4 are included in the A-MPDU to be subsequently transmitted by the STA of the transmitting station TX.

Then, STA2 of the transmitting station TX transmits an A-MPDU [D #2, D #4] including an A-MPDU subframe including the data D #2 and an A-MPDU subframe including the data D #4 to STA2 of the receiving station RX (step S69). In this example, STA2 of the receiving station RX that has received the A-MPDU [D #2, D #4] does not detect an error in both MPDUs of the data D #2 and D #4.

In this case, STA2 of the receiving station RX inputs the data D #2 received from the transmitting station TX to the link management unit LM of the receiving station RX (step S70).

Subsequently, STA2 of the receiving station RX inputs the data D #4 received from the transmitting station TX to the link management unit LM of the receiving station RX (step S71).

In addition, STA2 of the receiving station RX updates the reception bitmap RBM of STA2 of the receiving station RX on the basis of the result of receiving the A-MPDU [D #1, D #3]. Then, in response to the BlockAck request, which is not illustrated, STA2 of the receiving station RX transmits BlockAck [SSN=2, “101”] corresponding to the result of receiving the A-MPDU [D #2, D #4] to STA2 of the transmitting station TX (step S70). [SSN=2, “101”] indicates that the data D #2 of SN=2 and the data D #4 of SN=4 have been successfully received.

After the processing of steps S64 to S67 described above, STA1 of the transmitting station TX confirms whether or not SN=1 can be received and whether or not SN=3 can be received in the reception bitmap RBM in BlockAck on the basis of the transmission bitmap TBM [SSN=1, “101”] in the transmission buffer unit 610-1. In this example, STA1 of the transmitting station TX senses the transmission success of the data D #3 of SN=3 and senses the transmission failure of the data D #1 of SN=1 on the basis of the reception of BlockAck [SSN=1, “001”] and the transmission bitmap TBM [SSN=1, “101”] in the transmission buffer unit 610-1.

After the processing of steps S67 to S71 described above, STA2 of the transmitting station TX confirms whether or not SN=2 can be received and whether or not SN=4 can be received in the reception bitmap RBM in BlockAck on the basis of the transmission bitmap TBM [SSN=2, “101”] in the transmission buffer unit 610-2. In this example, STA2 of the transmitting station TX senses the transmission success of each of the data D #2 of SN=2 and the data D #4 of SN=4 on the basis of the reception of BlockAck [SSN=2, “101”] and the transmission bitmap TBM [SSN=2, “101”] in the transmission buffer unit 610-2.

Then, STA1 of the transmitting station TX deletes the data D #3 of SN=3 from the transmission buffer unit 610-1, and STA2 of the transmitting station TX deletes the data D #2 of SN=2 and the data D #4 of SN=4 from the transmission buffer unit 610-2. Then, STA1 of the transmitting station TX executes the retransmission processing of the data D #1 of SN=1 for which the transmission failure is sensed. Specifically, STA1 of the transmitting station TX transmits an A-MPDU [D #1] including an MPDU including the data D #1 to STA1 of the receiving station RX (step S73).

In this example, STA1 of the receiving station RX that has received the A-MPDU [D #1] does not detect an error in the MPDU including the data D #1. In this case, STA1 of the receiving station RX inputs the data D #1 received from the transmitting station TX to the link management unit LM of the receiving station RX (step S74).

In addition, STA1 of the receiving station RX updates the reception bitmap RBM of STA1 of the receiving station RX on the basis of the result of receiving the A-MPDU [D #1]. Then, in response to the BlockAck request, which is not illustrated, STA1 of the receiving station RX transmits BlockAck [SSN=1, “101”] corresponding to the result of receiving the A-MPDU [D #1] to STA1 of the transmitting station TX (step S75). [SSN=1, “101”] indicates that the data D #1 of SN=1 and the data D #3 of SN=3 each have been successfully received.

Upon receiving BlockAck [SSN=1, “101”], STA1 of the transmitting station TX senses the transmission success of the data D #1 of SN=1 on the basis of the transmission bitmap TBM [SSN=1, “101”] and the reception bitmap RBM. Then, STA1 of the transmitting station TX deletes the data D #1 of SN=1 from the transmission buffer unit 610-1. Then, the transmitting station TX completes the transmission processing of the data D #1 to D #4 to the receiving station RX in response to the deletion of the data D #1 and D #3 stored in the transmission buffer unit 610-1 and the data D #2 and D #4 stored in the transmission buffer unit 610-2.

<3> Advantageous Effects

With the information communication system 1 according to the embodiment described above, the efficiency of data communication while using multi-link can be improved. Hereinafter, the effects of the information communication system 1 according to the embodiment will be described below in detail.

Each of the access point AP and the wireless terminal apparatus WTA using a wireless LAN may have a plurality of STA functions that can use different bands such as 2.4 GHz, 5 GHz, and 6 GHz. In this case, between the access point AP and the wireless terminal apparatus WTA, for example, a wireless connection is established using one STA function among a plurality of STA functions, and data is transmitted and received. In addition, the access point AP and the wireless terminal apparatus WTA can establish the multi-link using a plurality of STA functions. In data communication using the multi-link, a plurality of bands can be used in combination, efficient communication can be realized, and a communication speed can be improved.

As a multi-link operation method, it is conceivable that the transmitting station TX allocates transmission of data having the same TID to a plurality of STA functions (links). However, in such a case, the sequence number SN of the transmitted data can be discontinuous in each of the plurality of links. When the sequence number SN becomes discontinuous, each STA function of the receiving station RX cannot determine regarding the data that cannot be received as to whether the data has failed to be received or it is the data that cannot be transmitted (that is, the data to which the sequence number SN of the missing number is assigned) when managing the data reception status. As a result, each STA function of the receiving station RX notifies the transmitting station TX of the data corresponding to the missing number as the reception failure in BlockAck. That is, inconsistency can occur in handling of the data corresponding to the missing number between the STA function of the transmitting station TX and the STA function of the receiving station RX.

Therefore, in the information communication system 1 according to the embodiment, each STA function of the transmitting station TX uses the transmission bitmap TBM to manage the data to be transmitted. In the transmission bitmap TBM, the sequence number SN of data to be transmitted in the STA function is stored.

When receiving the data from the transmitting station TX, each STA function of the receiving station RX sets the bit corresponding to the sequence number SN of the data that has been successfully received to be received in the reception bitmap RBM. Then, each STA function of the receiving station RX transmits BlockAck including the reception bitmap RBM to the transmitting station TX in response to a request from the transmitting station TX.

When receiving BlockAck from the receiving station RX, each STA function of the transmitting station TX confirms the delivery status of the sequence number SN indicated to be a transmission target in the transmission bitmap TBM. Specifically, each STA function of the transmitting station TX refers to the reception bitmap RBM in BlockAck in a state where the data of the missing number is excluded. In other words, the link management unit LM of the transmitting station TX refers to the reception bitmap RBM a notification of which is given from the STA function in a state where the reception bitmap RBM is masked by the transmission bitmap TBM corresponding to the STA function. Then, each STA function of the transmitting station TX retransmits the data that has failed to be delivered, to the receiving station RX.

Each STA function of the receiving station RX outputs the successfully received data to the rearranging buffer unit 422 common between the plurality of STA functions. The data accumulated in the rearranging buffer unit 422 is output to the LLC layer in response to the sequence numbers SN being ordered.

As described above, in the information communication system 1 according to the embodiment, each of the delivery confirmation by BlockAck and the retransmission processing is executed in units of STA functions. Then, by masking by the transmission bitmap TBM for each STA function, the sequence number SN of the data retransmitted by the STA function of the transmitting station TX and the sequence number SN of unreceived data a notification of which is given by BlockAck match.

Thus, in the information communication system 1 according to the embodiment, even in a case where data is distributed to a plurality of links while using multi-link, the reception status becomes consistent between the transmitting station TX and the receiving station RX, and data can be transmitted using the plurality of links. As a result, with the information communication system 1 according to the embodiment, the efficiency of data communication while using multi-link can be improved. In addition, since the information communication system 1 according to the embodiment can execute retransmission processing of data that has failed to be delivered by using BlockAck, reliability of data communication while using multi-link can be improved.

<4> Others

In the embodiment, the case where the transmitting station TX transmits the BlockAck request frame to the receiving station RX in order to request the receiving station RX to transmit BlockAck has been exemplified, but it is not limited thereto. Each STA function of the transmitting station TX may add information requesting BlockAck to the MAC header of the data frame. For example, information indicating Implicit BlockAckRequest is added to Ack Policy Indicator included in the QoS control field of the MAC header of each MPDU. In this case, when sensing that information indicating Implicit BlockAckRequest is added to Ack Policy Indicator included in the QoS control field of the MAC header of the received MPDU, each STA function of the receiving station RX transmits BlockAck to the transmitting station TX.

In addition, each STA function of the transmitting station TX may notify the receiving station RX of necessity or unnecessity of BlockAck by using a more data field added to the header of each MPDU. The more data field can be inserted into a predetermined portion of the MAC header. For example, when “more data” is “1”, each STA function of the receiving station RX waits for transmission of subsequent data. On the other hand, when “more data” is “0”, each STA function of the receiving station RX generates BlockAck with reception of the MPDU in which “more data” is “0” as a trigger.

In the above embodiment, each STA function may notify the corresponding link management unit LM when the link cannot be maintained due to movement of the wireless terminal apparatus WTA or the like. In addition, the link management unit LM2 of the wireless terminal apparatus WTA may change the state of the multi-link with respect to the link management unit LM1 of the access point AP on the basis of the notification from the STA function. Specifically, for example, the link management unit LM2 of the wireless terminal apparatus WTA and the link management unit LM1 of the access point AP may appropriately change the STA function used in the multi-link. When the state of the multi-link is changed, the link management units LM1 and LM2 update the link management information 51a and 51b, respectively. In addition, the link management units LM1 and LM2 may update the association between the traffic and the STA function according to an increase or decrease in the number of links.

The configuration and functional configuration of the information communication system 1 according to the embodiment may be another configuration. For example, the case where each of the access point AP and the wireless terminal apparatus WTA has three STA functions (radio signal processing units) has been exemplified, but it is not limited thereto. It is sufficient if the access point AP includes at least two radio signal processing units. Similarly, it is sufficient if the wireless terminal apparatus WTA includes at least two radio signal processing units. In addition, the number of channels that can be processed by each STA function can be appropriately set according to a frequency band to be used. Each of the wireless communication modules 13 and 23 may support wireless communication of a plurality of frequency bands by a plurality of communication modules, or may support wireless communication of a plurality of frequency bands by one communication module. In addition, the functional configurations of the access point AP and the wireless terminal apparatus WTA may be other names and grouping as long as the operations described in the embodiment can be executed.

In the information communication system 1 according to the embodiment, each of the CPU 10 included in the access point AP and the CPU 20 included in the wireless terminal apparatus WTA may be another circuit. For example, each of the access point AP and the wireless terminal apparatus WTA may include a micro processing unit (MPU) or the like instead of the CPU. Each processing described in the embodiment may be realized by dedicated hardware. The processing of each of the access point AP and the wireless terminal apparatus WTA may include both processing executed by software and processing executed by hardware, or may include only one of them.

In the embodiment, the flowcharts used to describe the operations are merely an example. Regarding the operations described in the embodiment, the order of processing may be changed to the possible extent, or other processing may be added. In addition, the formats of the radio frame described in the embodiment are merely an example. In the information communication system 1, another format may be used as long as the operations described in the embodiment can be executed.

In the present specification, the “MPDU” may be referred to as a data unit. When the transmitting station TX transmits the traffic allocated to the plurality of links, a group of MPDUs distributed to a certain STA function may be referred to as a “data unit group”. The transmission bitmap TBM and the reception bitmap RBM may be simply referred to as “information”. The transmission bitmap TBM may be referred to as “transmission information”. The reception bitmap RBM may be referred to as “reception information” or “delivery information”. The “rearrangement buffer unit 422” may be simply referred to as a “buffer unit”. The rearrangement processing in the rearrangement buffer unit 422 and the output of data to the third MAC processing unit 423 are executed, for example, under the control of the management unit 50.

Note that the present invention is not limited to the foregoing embodiment and various modifications can be made in the implementation stage without departing from the gist of the invention. In addition, each embodiment may be implemented in appropriate combination, and in that case, combined effects can be obtained. Furthermore, the embodiment described above includes various inventions, and various inventions can be extracted by a combination selected from a plurality of disclosed constituent elements. For example, even if some constituent elements are deleted from all the constituent elements described in the embodiment, in a case where the problem can be solved and the effects can be obtained, a configuration from which the constituent elements are deleted can be extracted as an invention.

### REFERENCE SIGNS LIST

1 Information communication system
10, 20 CPU
11, 21 ROM
12, 22 RAM
13, 23 Wireless communication module
14 Wired communication module
24 Display
25 Storage
30 Data processing unit
40 MAC frame processing unit
411 Data categorizing unit
412 First MAC processing unit
413 Data distribution unit
421 Second MAC processing unit
422 Rearrangement buffer unit
423 Third MAC processing unit
50 Management unit
60 Radio signal processing unit
610 Transmission buffer unit
611 Frame generation unit
612 Transmission/reception unit
613 Delivery confirmation unit
620 Transmission/reception unit
621 Frame processing unit
622 Reception status management unit
623 BlockAck generation unit
70 Application execution unit
LM1, LM2 Link management unit
BS Access point
WTA Wireless terminal apparatus
TX Transmitting station
RX Receiving station
SN Sequence number
RBM Reception bitmap
TBM Transmission bitmap
SSN Start sequence number
BMI Bitmap information

1. A transmitting station comprising:
a first radio signal processing unit configured to transmit a radio signal by using a first channel and store information indicating a sequence number of data to be transmitted;
a second radio signal processing unit configured to transmit a radio signal by using a second channel different from the first channel and store information indicating a sequence number of data to be transmitted; and
a link management unit configured to establish multi-link with a receiving station by using the first radio signal processing unit and the second radio signal processing unit and manage communication using the multi-link,
wherein
the link management unit is configured to distribute a plurality of data units into the first radio signal processing unit and the second radio signal processing unit,
the first radio signal processing unit is configured to transmit a first data unit group input from the link management unit among the plurality of data units to the receiving station, and store first information indicating a sequence number of a data unit included in the first data unit group, and
the second radio signal processing unit is configured to transmit a second data unit group input from the link management unit among the plurality of data units to the receiving station, and store second information indicating a sequence number of a data unit included in the second data unit group.

2. The transmitting station according to claim 1, wherein
when receiving a first frame including third information indicating a reception status of the first data unit group from the receiving station, the first radio signal processing unit is configured to determine whether a data unit included in the transmitted first data unit group has been successfully delivered based on a reception status of a sequence number matching a sequence number indicated by the first information among sequence numbers indicated by the third information, and
when receiving a second frame including fourth information indicating a reception status of the second data unit group from the receiving station, the second radio signal processing unit is configured to determine whether a data unit included in the transmitted second data unit group has been successfully delivered based on a reception status of a sequence number matching a sequence number indicated by the second information among sequence numbers indicated by the fourth information.

3. The transmitting station according to claim 2, wherein
the first radio signal processing unit includes a first buffer unit capable of storing the first data unit group, and
the second radio signal processing unit includes a second buffer unit capable of storing the second data unit group.

4. The transmitting station according to claim 2, wherein
the first radio signal processing unit is configured to set a data unit determined to have failed to be delivered on a basis of the first information and the third information as a retransmission target, and
the second radio signal processing unit is configured to set a data unit determined to have failed to be delivered on a basis of the second information and the fourth information as a retransmission target.

5. A receiving station comprising:
a first radio signal processing unit configured to receive a radio signal by using a first channel and store first information indicating a data reception status for each sequence number;
a second radio signal processing unit configured to receive a radio signal using a second channel different from the first channel and store second information indicating a data reception status for each sequence number; and
a link management unit is configured to establish multi-link with a transmitting station by using the first radio signal processing unit and the second radio signal processing unit and manage communication using the multi-link,
wherein
in an operation in which the transmitting station distributes and transmits a plurality of data units to which sequence numbers are assigned to the first radio signal processing unit and the second radio signal processing unit,
when receiving a first data unit group allocated to the first radio signal processing unit among the plurality of data units, the first radio signal processing unit is configured to output a data unit in which no error is detected among the received first data unit group to the link management unit,
when receiving a second data unit group allocated to the second radio signal processing unit among the plurality of data units, the second radio signal processing unit is configured to output a data unit in which no error is detected among the received second data unit group to the link management unit, and
the link management unit is configured to rearrange the data unit received from the first radio signal processing unit and the data unit received from the second radio signal processing unit according to sequence numbers, and output the plurality of data units with ordered sequence numbers to an upper layer.
